(19) United States
(12) Patent Application Publication
(10) Pub. No.: US 2013/0228459 A1
(43) Pub. Date: Sep. 5, 2013

(54) ELECTROLYZED WATER PRODUCING APPARATUS

(71) Applicant: Kokichi Hanaoka, Nagano (JP)

(72) Inventor: Kokichi Hanaoka, Nagano (JP)

(73) Assignees: SEKI Kazunori, Tokyo (JP); Bio-REDOX Laboratory Inc., Nagano (JP)

(21) Appl. No.: 13/883,695

(22) PCT Filed: Aug. 19, 2011
(86) PCT No.: PCT/JP2011/068785

§ 371 Date: May 6, 2013

(30) Foreign Application Priority Data
Nov. 24, 2010 (JP) 2010-261085

(51) Int. Cl. C02F 1/461

(52) U.S. Cl. CPC C02F 1/4618
USPC 204/257

(57) ABSTRACT

An electrolyzed water producing apparatus comprises an electrolysis unit including a diaphragm electrolytic cell and a diaphragmless electrolytic cell; a water supply pipe with a three-way valve; a water take-out pipe having one end connected to each anode chamber to remove anode electrolyzed water; a water take-out pipe having one end connected to each cathode chamber to remove cathode electrolyzed water; and a water take-out pipe provided with a free chlorine removing filter and having one end connected to each diaphragmless electrolytic chamber to remove mixed electrolyzed water. The diaphragm electrolytic cell contains a pair of electrode plates, and a plurality of electrolytic chambers, at least one of which includes an anode chamber and a cathode chamber. The diaphragmless electrolytic cell contains a pair of electrode plates, and diaphragmless electrolytic chambers which are the remaining electrolytic chambers.

### TECHNICAL FIELD

The present invention relates to an electrolyzed water production apparatus. More specifically, the invention relates to an electrolyzed water production apparatus which can produce three kinds of electrolyzed water including anode electrolyzed water produced on the anode side in electrolysis of water, cathode electrolyzed water produced on the cathode side, and mixed-electrolyzed water in which the anode electrolyzed water and the cathode electrolyzed water are mixed.

### BACKGROUND ART

An electrolyzed water production apparatus includes an electrolyzed water production apparatus having a format that includes a diaphragm electrolytic cell in which a pair of electrodes separated by a diaphragm is arranged and an electrolyzed water production apparatus having a format that includes a diaphragmless electrolytic cell in which a pair of electrodes is arranged without providing a diaphragm. Those electrolyzed water production apparatuses are used according to purposes.

In the diaphragm electrolytic cell, acidic electrolyzed water is produced on the anode side, and alkaline electrolyzed water is produced on the cathode side (the acidic electrolyzed water is hereinafter referred to as “anode electrolyzed water” and the alkaline electrolyzed water is hereinafter referred to as “cathode electrolyzed water”). The anode electrolyzed water and the cathode electrolyzed water produced in the diaphragm electrolytic cell are taken from the electrolyzed water production apparatus.

Electrolysis raw water (water to be electrolyzed) contains electrolyte. When the electrolyte contained in the electrolysis raw water is chloride, the anode electrolyzed water to be produced contains hydrochloric acid, hypochlorous acid, and dissolved oxygen as electrode reaction products. The hypochlorous acid exhibits strong chlorination action and oxidation action. Thus, the anode electrolyzed water is used for sterilization, for example. Meanwhile, the cathode electrolyzed water has been widely known as alkali ion water for drinking. An alkali ion water production apparatus is commercially available as a medical instrument and the like and is widely used.

In the diaphragmless electrolytic cell, the anode electrolyzed water and the cathode electrolyzed water produced by electrolysis are mixed in the cell (the mixture is hereinafter referred to as “mixed-electrolyzed water”). Thus, the mixed-electrolyzed water is kept in neutrality. In the mixed-electrolyzed water, the dissolved oxygen concentration, the dissolved hydrogen concentration, the hypochlorous acid concentration, and so on change compared with the electrolysis raw water. Those concentrations are changed by, for example, kind and concentration of solute contained in the electrolysis raw water and the magnitude of electrolysis energy applied to the electrolysis raw water. In general, in electrolyzed water produced using high electrolysis energy, the dissolved oxygen concentration, the dissolved hydrogen concentration, the hypochlorous acid concentration, and so on significantly change compared with the electrolysis raw water. The mixed-electrolyzed water is used in various applications.

In order to produce the anode electrolyzed water, the cathode electrolyzed water, and the mixed-electrolyzed water in a single apparatus, the apparatus is required to have a diaphragm electrolytic cell and a diaphragmless electrolytic cell. In order to enhance the ability to produce electrolyzed water, it is preferable that the electrolyzed water production apparatus includes a plurality of electrolytic cells. However, such an electrolyzed water production apparatus including a plurality of electrolytic cells is expensive, because the use of electrode plates formed of noble metal such as platinum is increased.

Patent Document 1 discloses an electrolyzed water production apparatus including a diaphragm electrolytic cell and a diaphragmless electrolytic cell. In this apparatus, the diaphragm electrolytic cell and the diaphragmless electrolytic cell are separated. When the number of electrolytic cells provided in the electrolyzed water production apparatus is increased, the use of the electrode plates is increased, and therefore, it becomes expensive. The size of a housing supporting those components increases to increase the size of the electrolyzed water production apparatus.

### CITATION LIST

### Patent Documents

Patent Document 1: JP 1998-118654 A

### SUMMARY OF INVENTION

### Technical Problem

This invention provides an electrolyzed water production apparatus which can produce an arbitrarily selected combination of three kinds of electrolyzed water:
(1) anode electrolyzed water and cathode electrolyzed water;
(2) mixed-electrolyzed water; and
(3) anode electrolyzed water, cathode electrolyzed water, and mixed-electrolyzed water,
   can be manufactured at low cost, and has a simplified structure.

### Solution to Problem

As a result of intensive studies made by the present inventors to solve the above problems, the inventors have devised a configuration in which in an electrolyzed water production apparatus having a plurality of electrolytic cells, an electrode plate used in the electrolytic cell is also used as an electrode plate used in an adjacent electrolytic cell. The inventors further have devised a configuration in which a valve is installed upstream of an electrolysis section, and electrolyzed water to be produced is switched between anyone of (a) anode electrolyzed water and cathode electrolyzed water, (b) mixed-electrolyzed water, and (c) anode electrolyzed water, cathode electrolyzed water, and mixed-electrolyzed water. The present invention has been completed based on such finding.

The present invention to solve the above problems is as follows.

An electrolyzed water production apparatus includes: an electrolysis section which comprises a plurality of electrolysis chambers comprising a pair of electrode plates, provided in a cell near one facing side wall of the cell in parallel with the one side wall, and at the same time partitioned by at least one electrode plate by dividing the inside of the cell in a watertight manner by at least one electrode plate in parallel with the one side wall, constitutes a diaphragm electrolytic cell having an anode chamber and a cathode chamber, provided by dividing the electrolysis chamber into two portions with a diaphragm attached in at least one electrolysis chamber in parallel with the at least one electrode plate, and comprising a pair of electrode plates, and constitutes a diaphragmless electrolytic cell having a diaphragmless electrolytic chamber in a remaining electrolytic chamber and comprising a pair of electrode plates; a wiring which connects the electrode plate in the cell alternately to an anode and a cathode of a DC power supply; a water supply pipe which comprises interposing a three-way valve and supplies electrolytic raw water to any one of the following (1) to (3) by switching the three-way valve:
(1) an anode chamber and a cathode chamber in each diaphragm electrolytic cell;
(2) a diaphragmless electrolytic chamber in each diaphragmless electrolytic cell; and
(3) the anode chamber and the cathode chamber in each diaphragm electrolytic cell and a diaphragmless electrolytic chamber in the diaphragmless electrolytic cell;

a water extraction pipe whose one end is coupled to each anode chamber and through which each anode electrolyzed water in each anode chamber is extracted outside; a water extraction pipe whose one end is coupled to each cathode chamber and through which each cathode electrolyzed water in each cathode chamber is extracted outside; and a water extraction pipe in which a free chlorine removal filter is interposed, whose one end is coupled to each diaphragmless electrolytic chamber, and through which mixed-electrolyzed water is extracted outside from each diaphragmless electrolytic chamber, wherein the three-way valve is switched to thereby switch electrolyzed water to be produced between any one of the following (a) to (c):
(a) anode electrolyzed water and cathode electrolyzed water;
(b) the mixed-electrolyzed water; and
(c) the anode electrolyzed water, the cathode electrolyzed water, and the mixed-electrolyzed water.

### Advantageous Effects of the Invention

An electrolyzed water production apparatus (hereinafter referred to as “this apparatus”) according to this invention can reduce the number of electrode plates constituting the apparatus. Further, a housing of the apparatus can be reduced in size. Therefore, manufacturing and maintenance costs are low.

Since this apparatus is provided with a plurality of electrolytic cells, electrolyzed water production capacity is large. Accordingly, when a small amount of electrolytic raw water is supplied, electrolyzed water to which a high electrolysis energy is applied can be produced.

In this apparatus, electrolyzed water to be produced can be switched between any one of (a) anode electrolyzed water and cathode electrolyzed water, (b) mixed-electrolyzed water, and (c) anode electrolyzed water, cathode electrolyzed water, and mixed-electrolyzed water by switching a valve.

### BRIEF DESCRIPTION OF DRAWINGS

FIG. 1 is a schematic configuration diagram showing an example of this apparatus.

FIGS. 2A to 2D are explanatory views showing an example in which electrode plates are shared.

FIG. 3 is an explanatory view showing another configuration example of an electrolysis section.

FIG. 4 is a schematic configuration diagram showing a yet another configuration example of this apparatus.

FIG. 5 is a schematic configuration diagram showing a yet further another configuration example of this apparatus.

### REFERENCE SIGNS LIST

100, 200, 300 electrolyzed water production apparatus
50 electrolysis section
11 water supply pipe
15 switching valve
17, 19 supply pipe
21, 23, 25, 27 anode plate
31, 33, 35 cathode plate
41, 43, 45 diaphragm
51, 53, 55, 57 side wall
16 water extraction pipe
63 water extraction pipe
65 water extraction pipe
67 piping
71, 73, 75 free chlorine removal filter
81, 84, 87 anode chamber
82, 85, 88 cathode chamber
83, 86, 89 mixed electrolysis chamber
81a to 89a supply port
81b to 89b discharge port
150 electrolysis section
101 to 103, 111 to 113, 121 to 123, 131 to 133 electrode plate
104, 114, 115, 124 diaphragm
105, 116, 118, 126 anode chamber
106, 117, 119, 127 cathode chamber
107, 125, 134, 135 mixed electrolysis chamber

### DESCRIPTION OF EMBODIMENTS

(1) Configuration of this Apparatus

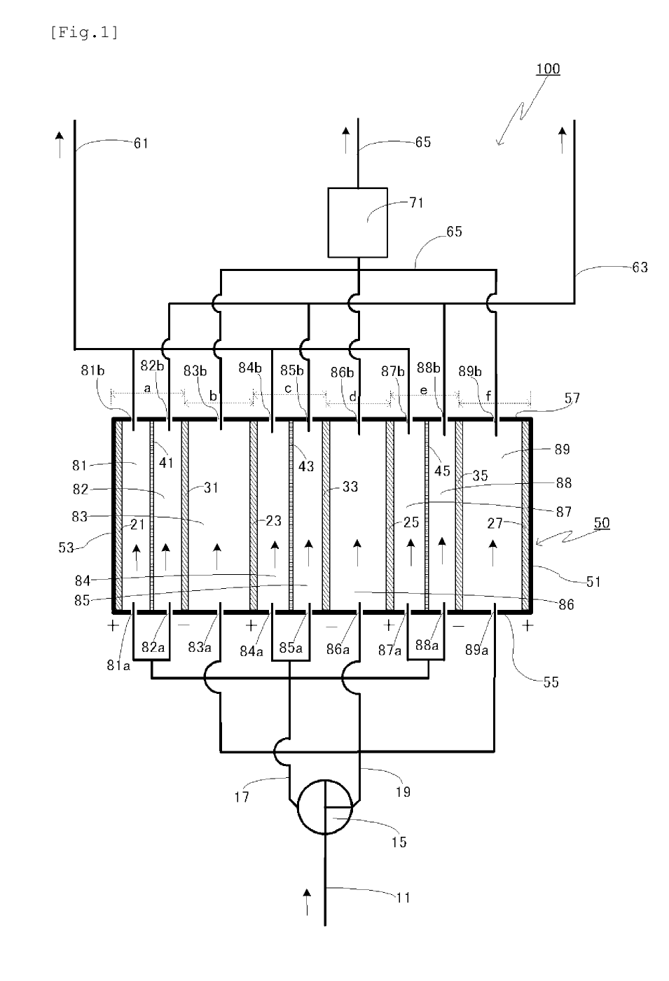

First, the configuration of this apparatus will be described. FIG. 1 is a schematic configuration diagram showing an example of this apparatus.

In FIG. 1, reference numeral 100 is an electrolyzed water production apparatus, and reference numeral 50 is an electrolysis section. The inner shape of the electrolysis section 50 is a hollow box shape. The electrolysis section 50 includes anode plates 21 and 27 arranged near side walls 51 and 53 facing each other so that the anode plates 21 and 27 are in parallel with the side walls 51 and 53. There are provided cathode plates 31, 33, and 35 and anode plates 23 and 25 alternately arranged between the anode plates 21 and 27 in parallel with the side walls 51 and 53. Accordingly, the inside of the electrolysis section 50 is partitioned into six spaces in a liquid-tight manner by the anode plates 23 and 25 and the cathode plates 31, 33, and 35. The anode plates 21, 23, 25, and 27 are connected to an anode of a DC power supply (not shown) through wiring, and the cathode plates 31, 33, and 35 are connected to a cathode of the DC power supply (not shown) through wiring.

The anode plate 21 and the cathode plate 31, the anode plate 23 and the cathode plate 33, and the anode plate 25 and the cathode plate 35 are provided respectively with diaphragms 41, 43, and 45 in between so that the diaphragms 41, 43, and 45 are situated in parallel with the anode plates 21, 23, and 25 and the cathode plates 31, 33, and 35.

According to the above constitution, the electrolysis section 50 includes a diaphragm electrolytic cell “a” constituted of a pair of electrode plates, constituted of the anode plate 21 and the cathode plate 31, the diaphragm 41, and the side walls 55 and 57 perpendicular to the side walls 51 and 53. The electrolysis section 50 further includes a diaphragm electrolytic cell “c” constituted of a pair of electrode plates, constituted of the anode plate 23 and the cathode plate 33, the diaphragm 43, and the side walls 55 and 57. The electrolysis section 50 furthermore includes a diaphragm electrolytic cell “e” constituted of a pair of electrode plates, constituted of the anode plate 25 and the cathode plate 35, the diaphragm 45, and the side walls 55 and 57.

Similarly, the electrolysis section 50 includes a diaphragmless electrolytic cell “b” constituted of a pair of electrode plates, constituted of the cathode plate 31 and the anode plate 23, and the side walls 55 and 57. The electrolysis section 50 further includes a diaphragmless electrolytic cell “d” constituted of a pair of electrode plates, constituted of the cathode plate 33 and the anode plate 25, and the side walls 55 and 57. The electrolysis section 50 furthermore includes a diaphragmless electrolytic cell “f” constituted of a pair of electrode plates, constituted of the cathode plate 35 and the anode plate 27, and the side walls 55 and 57.

The diaphragm electrolytic cell “a” includes an anode chamber 81 surrounded by the anode plate 21, the diaphragm 41, and the side walls 55 and 57 and a cathode chamber 82 surrounded by the diaphragm 41, the cathode plate 31, and the side walls 55 and 57. The diaphragm electrolytic cell “c” includes an anode chamber 84 surrounded by the anode plate 23, the diaphragm 43, and the side walls 55 and 57 and a cathode chamber 85 surrounded by the diaphragm 43, the cathode plate 33, and the side walls 55 and 57. The diaphragm electrolytic cell “e” includes an anode chamber 87 surrounded by the anode plate 25, the diaphragm 45, and the side walls 55 and 57 and a cathode chamber 88 surrounded by the diaphragm 45, the cathode plate 35, and the side walls 55 and 57.

The diaphragmless electrolytic cell “b” includes a mixed electrolysis chamber 83 surrounded by the cathode plate 31, the anode plate 23, and the side walls 55 and 57. Similarly, the diaphragmless electrolytic cell “d” includes a mixed electrolysis chamber 86 surrounded by the cathode plate 33, the anode plate 25, and the side walls 55 and 57. The diaphragmless electrolytic cell “f” includes a mixed electrolysis chamber 89 surrounded by the cathode plate 35, the anode plate 27, and the side walls 55 and 57.

In this apparatus, the cathode plate 31 constituting the diaphragm electrolytic cell “a” is the same as the cathode plate 31 constituting the diaphragmless electrolytic cell “b”. Similarly, the anode plate 23 constituting the diaphragmless electrolytic cell “b” is the same as the anode plate 23 constituting the diaphragm electrolytic cell “c”. The cathode plate 33 constituting the diaphragm electrolytic cell “c” is the same as the cathode plate 33 constituting the diaphragmless electrolytic cell “d”. The anode plate 25 constituting the diaphragmless electrolytic cell “d” is the same as the anode plate 25 constituting the diaphragm electrolytic cell “e”. The cathode plate 35 constituting the diaphragm electrolytic cell “e” is the same as the cathode plate 35 constituting the diaphragmless electrolytic cell “f”. Namely, in the cathode plates 31, 33, and 35 and the anode plates 23 and 25, a single electrode plate is shared in two electrolytic cells. The total number of the electrode plates used in the electrolysis section 50 is seven.

The side wall 55 constituting the anode chamber 81 is provided with a water supply port 81a. The side wall 57 constituting the anode chamber 81 is provided with a water discharge port 81b. Similarly, the side wall 55 constituting the anode chamber 84 is provided with a water supply port 84a. The side wall 57 constituting the anode chamber 84 is provided with a water discharge port 84b. The side wall 55 constituting the anode chamber 87 is provided with a water supply port 87a. The side wall 57 constituting the anode chamber 87 is provided with a water discharge port 87b.

The side wall 55 constituting the cathode chamber 82 is provided with a water supply port 82a. The side wall 57 constituting the cathode chamber 82 is provided with a water discharge port 82b. Similarly, the side wall 55 constituting the cathode chamber 85 is provided with a water supply port 85a. The side wall 57 constituting the cathode chamber 85 is provided with a water discharge port 85b. The side wall 55 constituting the cathode chamber 88 is provided with a water supply port 88a. The side wall 57 constituting the cathode chamber 88 is provided with a water discharge port 88b.

The side wall 55 constituting the mixed electrolysis chamber 83 is provided with a water supply port 83a. The side wall 57 constituting the mixed electrolysis chamber 83 is provided with a water discharge port 83b. Similarly, the side wall 55 constituting the mixed electrolysis chamber 86 is provided with a water supply port 86a. The side wall 57 constituting the mixed electrolysis chamber 86 is provided with a water discharge port 86b. The side wall 55 constituting the mixed electrolysis chamber 89 is provided with a water supply port 89a. The side wall 57 constituting the mixed electrolysis chamber 89 is provided with a water discharge port 89b.

Reference numeral 11 is a water supply pipe through which electrolysis raw water is supplied from its one end. The other end of the water supply pipe 11 is connected to a switching valve 15. The switching valve 15 is connected in a switchable manner to one end of a supply pipe 17 through which the electrolysis raw water is supplied to the diaphragm electrolytic cells “a”, “c”, and “e” and to one end of a supply pipe 19 through which the electrolysis raw water is supplied to the diaphragmless electrolytic cells “b”, “d”, and “f”.

The other end side of the supply pipe 17 is branched and connected to the water supply ports 81a, 82a, 84a, 85a, 87a, and 88a. The other end side of the supply pipe 19 is branched and connected to the water supply ports 83a, 86a, and 89a.

Reference numeral 61 is a water extraction pipe through which anode electrolyzed water is extracted from the anode chambers 81, 84, and 87. One end side of the water extraction pipe 61 is branched and connected to the water discharge ports 81b, 84b, and 87b. Reference numeral 63 is a water extraction pipe through which cathode electrolyzed water is extracted from the cathode chambers 82, 85, and 88. One end side of the water extraction pipe 63 is branched and connected to the water discharge ports 82b, 85b, and 88b.

Reference numeral 65 is a water extraction pipe through which mixed-electrolyzed water is extracted from the mixed electrolysis chambers 83, 86, and 89. One end side of the water extraction pipe 65 is branched and connected to the water discharge ports 83b, 86b, and 89b. There is interposed a free chlorine removal filter 71 in the water extraction pipe 65.

The anode plates 21, 23, 25, and 27 and the cathode plates 31, 33, and 35 are formed of an electrochemically inactive metal material. As the metal material, platinum, platinum-alloy, or the like is preferably used. The thickness of those electrode plates is preferably 0.1 to 2.0 mm and particularly 0.5 to 1.5 mm. An interval between the anode plate and the cathode plate is 3.0 to 1.0 mm, and preferably 2.0 to 1.0 mm.

As the diaphragms 41, 43, and 45, diaphragms conventionally used as electrolysis diaphragms such as an ion-exchange membrane and an uncharged membrane can be suitably used. For example, a non-charged membrane produced by Japan Gore-Tex, Inc. (called Gore-Tex SGT-010-135-1) is used.

The free chlorine removal filter 71 may be installed in any place downstream of the electrolytic cell. As the free chlorine removal filter 71, a well-known filter using an absorbent such as activated carbon or a zeolite can be used. When electrolyzed water is not used for drinking, the free chlorine removal filter may not be interposed. The free chlorine removal filter may further be installed at the upper stream of the electrolysis section.

In FIG. 1, although a three-way valve is used as the switching valve 15, the invention is not limited thereto, and any suitable type such as a ball valve or a float type valve maybe used as long as it can freely switch a flow path.

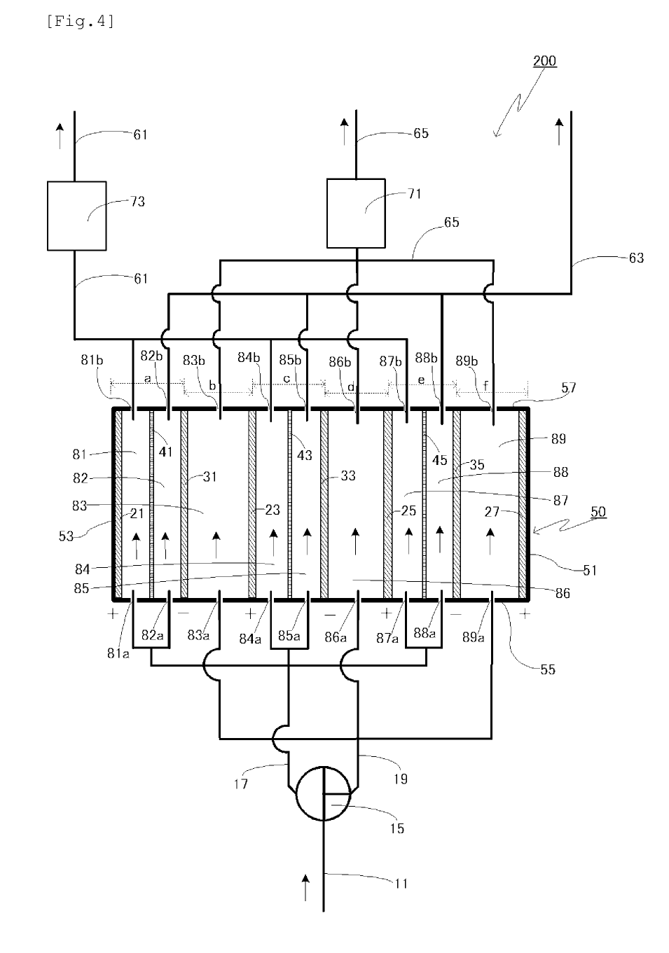

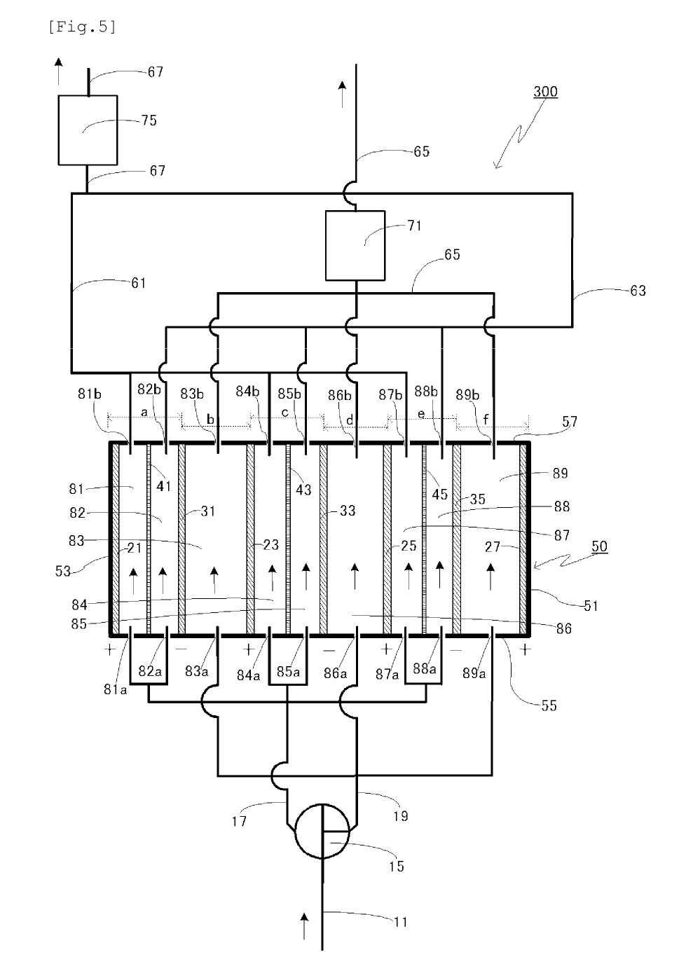

FIGS. 4 and 5 are schematic configuration diagrams showing another configuration example of this electrolyzed water production apparatus. In this electrolyzed water production apparatus, the same components as those in the electrolyzed water production apparatus of FIG. 1 are denoted by the same reference numerals, and explanations thereof are omitted.

In FIG. 4, a free chlorine removal filter 73 is interposed in the water extraction pipe 61 of an electrolyzed water production apparatus 200. Hydrochloric acid, hypochlorous acid, and the like contained in the anode electrolyzed water are removed by the free chlorine removal filter 73.

In FIG. 5, the water extraction pipes 61 and 63 of the electrolyzed water production apparatus 300 are connected to a piping 67. A free chlorine removal filter 75 is interposed in the piping 67. In the piping 67, anode electrolyzed water and cathode electrolyzed water are mixed. Hydrochloric acid, hypochlorous acid, and the like contained in the mixed electrolyzed water are removed by the free chlorine removal filter 75.

Electrolyzed water from which hydrochloric acid, hypochlorous acid, and so on have been removed can be provided for drinking.

(2) Operation of this Apparatus

Next, the operation of each section will be described when electrolyzed water is produced using the electrolyzed water production apparatus 100 of FIG. 1 will be described. The arrow in FIG. 1 shows a water flowing direction in the apparatus. Electrolytic raw water supplied from one end of the water supply pipe 11 is fed to the switching valve 15.

When the switching valve 15 is switched so that the electrolytic raw water is supplied to the supply pipe 17, the electrolytic raw water is supplied into the anode chambers 81, 84, and 87 and the cathode chambers 82, 85, and 88 respectively from the supply ports 81a, 82a, 84a, 85a, 87a, and 88a through the supply pipe 17. The electrolytic raw water supplied into the anode chambers 81, 84, and 87 and the cathode chambers 82, 85, and 88 is electrolyzed by a DC voltage/current applied to the anode plates 21, 23, 25, and 27 and the cathode plates 31, 33, and 35.

The anode electrolyzed water is produced in the anode chambers 81, 84, and 87 by electrolysis, and the cathode electrolyzed water is produced in the cathode chambers 82, 85, and 88. The anode electrolyzed water is extracted outside the apparatus from the discharge ports 81b, 84b, and 87b through the water extraction pipe 61. The anode electrolyzed water as acidic electrolyzed water is used in various applications. The cathode electrolyzed water is extracted outside the apparatus from the discharge ports 82b, 85b, and 88b through the water extraction pipe 63. The cathode electrolyzed water as alkaline electrolyzed water is used in various applications.

When the switching valve 15 is switched so that the electrolytic raw water is supplied to the supply pipe 19, the electrolytic raw water is supplied into the mixed electrolysis chambers 83, 86, and 89 respectively from the supply ports 83a, 86a, and 89a through the supply pipe 19. The electrolytic raw water supplied into the mixed electrolysis chambers 83, 86, and 89 is electrolyzed by a DC voltage/current applied to the anode plates 23 and 25 and the cathode plates 31, 33, and 35. The mixed-electrolyzed water is produced in the mixed electrolysis chambers 83, 86, and 89 by electrolysis. The mixed-electrolyzed water is extracted outside the apparatus from the discharge ports 83b, 86b, and 89b through the free chlorine removal filter 71 and the extraction pipe 65. The mixed-electrolyzed water as neutral electrolyzed water is used in various applications.

When the switching valve 15 is switched so that the electrolytic raw water is supplied to the supply pipes 17 and 19, the anode electrolyzed water, the cathode electrolyzed water, and the mixed-electrolyzed water are produced.

An electric current applied to an electrode plate in each of the electrolytic cells “a” to “f” is preferably not less than 0.5 A with respect to electrolytic raw water having a flow rate of 1 L per minute and particularly 1 to 5 A. When the electric current is less than 0.5 A, an amount of dissolved oxygen in electrolyzed water cannot be made larger than that of the electrolytic raw water. Moreover, hydrogen cannot be dissolved in the electrolyzed water.

The flow rate of the electrolytic raw water supplied to each of the electrolytic cells “a” to “f” is preferably 0.5 to 10 L/min and particularly 1 to 5 L/min.

Examples of the electrolytic raw water include tap water, well water, and an electrolyte aqueous solution such as a sodium chloride aqueous solution.

The ionic strength of the electrolytic raw water is preferably not less than 0.1 mM in total and particularly 0.1 to 0.5 mM in total. An electrolyte adding apparatus is provided in this apparatus, and electrolyte may be added to the electrolytic raw water in this apparatus.

This apparatus 100 is provided with three diaphragm electrolytic cell and three diaphragmless electrolytic cells. Thus, the amount of water to be treated in one electrolytic cell can be reduced compared with an electrolyzed water production apparatus having only one electrolytic cell. Namely, in the electrolyzed water produced using this apparatus 100, the electrolysis energy applied to the electrolyzed water can be raised compared with electrolyzed water produced using a conventional apparatus. In electrolyzed water produced using a high electrolysis energy, pH, an oxidation-reduction potential, a dissolved oxygen concentration, a dissolved hydrogen concentration, a hypochlorous acid concentration, and so on can be significantly changed.

The electrolytic raw water contains hydrochloric acid in the form of, for example, Cl₋, Cl₂ and OCl⁻. Hypochlorous acid is produced with the hydrochloric acid by electrolysis. Hypochlorous acid has a bactericidal action. When the electrolyzed water is used for sterilization, it is preferable that the electrolyzed water is taken outside the apparatus without being passed through a free chlorine removal filter. Meanwhile, when the electrolyzed water is used for drinking, hypochlorous acid is required to be removed.

In this apparatus 100, the electrolytic raw water can be supplied by connecting one end of the water supply pipe 11 to a facet of tap water. In this case, in this apparatus, electrolytic raw water and electrolyzed water produced by electrolyzing the electrolytic raw water can be transferred by the water pressure of the tap water.

### (3) Example of Sharing of Electrode Plate

In this apparatus, the number of electrode plates can be reduced compared with the prior art. In a conventional electrolyzed water production apparatus, two electrode plates are required to be provided in each electrolytic cell. Namely, the number of the electrode plates required for an electrolyzed water production apparatus having n electrolytic cells is at least (2n). Meanwhile, in this apparatus, an anode plate and/or a cathode plate constituting a single electrolytic cell is shared as an electrode plate constituting another electrolytic cell. Thus, the number of the electrode plates required for the electrolyzed water production apparatus having n electrolytic cells is at least (n+1).

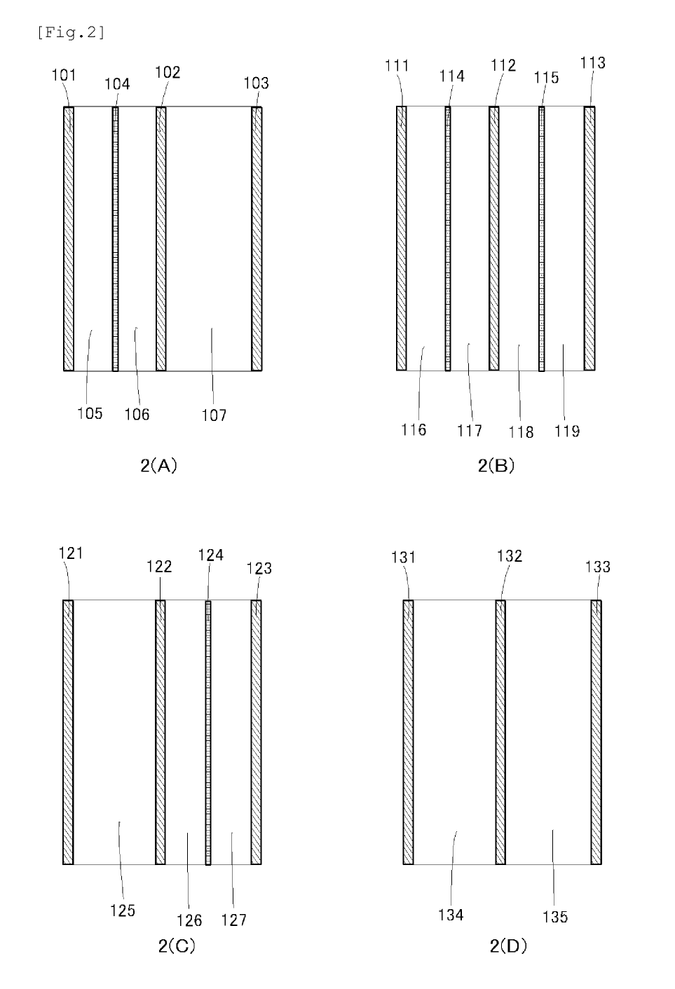

The examples of sharing of the electrode plate includes a combination shown in FIG. 2. FIG. 2A shows an example in which a diaphragm electrolytic cell and a diaphragmless electrolytic cell are combined. In FIG. 2A, reference numerals 101, 102, and 103 are electrode plates. A diaphragm 104 is situated between the electrode plates 101 and 102, and a diaphragm electrolytic cell is formed. The diaphragmless electrolytic cell is formed by the electrode plates 102 and 103. Namely, the electrode plate 102 constitutes an electrode plate of the diaphragm electrolytic cell and, at the same time, constitutes an electrode plate of the diaphragmless electrolytic cell.

FIG. 2B shows an example in which two diaphragm electrolytic cells are combined. In FIG. 2B, reference numerals 111, 112, and 113 are electrode plates. A diaphragm 114 is situated between the electrode plates 111 and 112, and a diaphragm electrolytic cell is formed. Meanwhile, a diaphragm 115 is situated between the electrode plates 112 and 113, and another diaphragm electrolytic cell is formed. Namely, the electrode plate 112 constitutes an electrode plate of one diaphragm electrolytic cell and, at the same time, constitutes an electrode plate of another diaphragm electrolytic cell.

FIG. 2C shows an example in which a diaphragm electrolytic cell and a diaphragmless electrolytic cell are combined. In FIG. 2C, reference numerals 121, 122, and 123 are electrode plates. The diaphragmless electrolytic cell is formed by the electrode plates 121 and 122. A diaphragm 124 is situated between the electrode plates 122 and 123, and the diaphragm electrolytic cell is formed. Namely, the electrode plate 122 constitutes the electrode plate of the diaphragmless electrolytic cell and, at the same time, constituting the electrode plate of the diaphragm electrolytic cell.

FIG. 2D shows an example in which two diaphragmless electrolytic cells are combined. In FIG. 2D, reference numerals 131, 132, and 133 are electrode plates. One diaphragmless electrolytic cell is formed by the electrode plates 131 and 132. The other diaphragmless electrolytic cell is formed by the electrode plates 132 and 133. Namely, the electrode plate 132 constitutes an electrode plate of one diaphragmless electrolytic cell and, at the same time, constitutes an electrode plate of the other diaphragmless electrolytic cell.

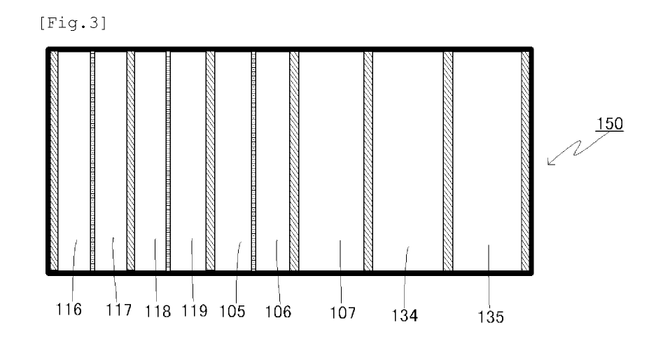

The electrolysis section can be freely designed by the combinations of FIGS. 2A to 2D. FIG. 3 is an explanatory view showing other configuration example of the electrolysis section. An electrolysis section 150 includes anode chambers 116, 118, and 105, cathode chambers 117, 119, and 106, and mixed electrolysis chambers 107, 134, and 135. Namely, a diaphragm electrolytic cell, a diaphragm electrolytic cell, a diaphragm electrolytic cell, a diaphragmless electrolytic cell, a diaphragmless electrolytic cell, and a diaphragmless electrolytic cell are provided from the left side of the drawing. The number of the electrode plates used in the electrolysis section 150 is seven in total.

1. An electrolyzed water production apparatus comprising:
an electrolysis section which comprises a plurality of electrolysis chambers comprising a pair of electrode plates, provided in a cell near one facing side wall of the cell in parallel with the one side wall, and at the same time partitioned by at least one electrode plate by dividing the inside of the cell in a watertight manner by at least one electrode plate in parallel with the one side wall, constitutes a diaphragm electrolytic cell having an anode chamber and a cathode chamber, provided by dividing the electrolysis chamber into two portions with a diaphragm attached in at least one electrolysis chamber in parallel with the at least one electrode plate, and comprising a pair of electrode plates, and constitutes a diaphragmless electrolytic cell having a diaphragmless electrolytic chamber in a remaining electrolytic chamber and comprising a pair of electrode plates;
a wiring which connects the electrode plate in the cell alternately to an anode and a cathode of a DC power supply;
a water supply pipe which comprises interposing a three-way valve and supplies electrolytic raw water to any one of the following (1) to (3) by switching the three-way valve:
(1) an anode chamber and a cathode chamber in each diaphragm electrolytic cell;
(2) a diaphragmless electrolytic chamber in each diaphragmless electrolytic cell; and
(3) the anode chamber and the cathode chamber in each diaphragm electrolytic cell and a diaphragmless electrolytic chamber in the diaphragmless electrolytic cell;
a water extraction pipe whose one end is coupled to each anode chamber and through which each anode electrolyzed water in each anode chamber is extracted outside;
a water extraction pipe whose one end is coupled to each cathode chamber and through which each cathode electrolyzed water in each cathode chamber is extracted outside; and
a water extraction pipe in which a free chlorine removal filter is interposed, whose one end is coupled to each diaphragmless electrolytic chamber, and through which mixed-electrolyzed water is extracted outside from each diaphragmless electrolytic chamber,
wherein the three-way valve is switched to thereby switch electrolyzed water to be produced between any one of the following (a) to (c):
(a) anode electrolyzed water and cathode electrolyzed water;
(b) the mixed-electrolyzed water; and
(c) the anode electrolyzed water, the cathode electrolyzed water, and the mixed-electrolyzed water.
